(19) United States
(12) Patent Application Publication
(10) Pub. No.: US 2023/0022017 A1
(43) Pub. Date: Jan. 26, 2023

(54) PROCESS FOR THE PREPARATION OF DISPERSING AGENTS IN A SOLID FORM AND THEIR USE IN MINERAL BINDING COMPOSITIONS

(71) Applicant: SIKA TECHNOLOGY AG, Baar (CH)

(72) Inventors: Denise MUTHS-KERN, Zürich (CH); Rasid SAHINAGIC, Seewen (CH); Christina HAMPEL, Rütihof (CH); Jörg ZIMMERMANN, Winterthur (CH); Nicole JAGIELSKI, Zürich (CH)

(73) Assignee: SIKA TECHNOLOGY AG, Baar (CH)

(21) Appl. No.: 17/782,231

(22) PCT Filed: Jan. 19, 2021
(86) PCT No.: PCT/EP2021/050979

§ 371 Date: Jun. 3, 2022

(30) Foreign Application Priority Data
Jan. 23, 2020 (EP) 20153474.0

(51) Int. Cl. C04B 24/26; C08G 81/02; C04B 28/14; C04B 40/00

(52) U.S. Cl. CPC C04B 24/2694; C08G 81/025; C04B 28/147; C04B 40/0042; C04B 2103/0059

(57) ABSTRACT

A process for preparing powdered dispersants comprising at least 90% by weight of at least one copolymer CP of the polycarboxylate ether type. The powdered dispersants can be easily dispersed in water. The invention also relates to the use of such powdered dispersants in mineral binder compositions, in particular dry mortars, concrete or gypsum formulations.

### TECHNICAL FIELD

The present invention relates to a process for producing pulverulent dispersants, comprising in all cases at least one copolymer CP of the polycarboxylate ether type. The pulverulent dispersants can be easily dispersed in water. The present invention also relates to the use of such pulverulent dispersants in mineral binder compositions.

### BACKGROUND

Copolymers of polycarboxylates and polyalkylene glycols, known as polycarboxylate ethers (PCEs), have been known for many years as dispersants for aqueous dispersions, in particular for aqueous dispersions of mineral binders. PCEs act as flow agents, reducing the amount of water needed to achieve a given flowability in a given unhardened mineral binder composition. Reducing the water content in mineral binder compositions, particularly in cementitious compositions, is desirable because it results in reduced separation of solid constituents in the unhardened composition and in increased compressive strength in the hardened composition.

PCEs are typically produced in aqueous solution or occur as aqueous polymer solutions. The disadvantage of these aqueous solutions is the high transport costs, since a high proportion of solvent has to be transported as well. Aqueous solutions are moreover frost-sensitive, which means not only that they can freeze but that solids can crystallize out under cool storage conditions. This necessitates special storage conditions. Having the PCEs in a solid form, such as in the form of a powder, can overcome these disadvantages. For various uses, it is additionally desirable for PCEs to be in the form of a powder. For example, the production of dry mortars using pulverulent PCEs is considerably simplified.

WO 2003/080714 (Sika Switzerland) describes the production of solid polymers of the polycarboxylate ether type by comminution of a cooled polymer melt. A disadvantage of the polymer powders obtained is that they have a rather low melting point/softening point, as a result of which undesired melting or softening processes and, for example, caking can occur at elevated temperatures, for example during storage or transport.

CN 101824125 (Jiangsu Dingda) describes a process in which PCEs are converted into the powder form by spray drying. A disadvantage of a spray drying process is however the high thermal stress on the polymers during drying, which can lead to undesirable decomposition reactions. In addition, there is also the risk of a dust explosion in the spray tower, which leads to increased expenditure on safety measures in the production facility.

WO 2006/129883 (Nippon Shokubai) discloses a pulverulent dispersant based on polycarboxylate ethers that can be produced for example in a film drying method. Polycarboxylate ethers may be neutralized to a maximum extent of 50%. Higher degrees of polymer neutralization are described as disadvantageous in respect of the solubility of the PCEs in water and the influence of the PCEs on the processability of mineral binder compositions.

There is therefore a need for processes that can be used to convert polymeric dispersants based on polycarboxylate ethers into solid powders and that overcome the disadvantages described above.

### SUMMARY OF THE INVENTION

The object of the present invention is to provide an improved process with which dispersants can be obtained in solid form, the dispersants comprising or consisting of copolymers based on polycarboxylate ethers and/or polycarboxylate esters. In particular, the copolymers should in solid form have a particularly high melting point/softening point in order to avoid difficulties during storage and transport.

It has surprisingly been found that this object is achieved by a process as claimed in claim 1.

The present invention accordingly provides a process for producing a dispersant in solid form, wherein the dispersant comprises at least 90% by weight, preferably at least 95% by weight, in particular at least 98.5% by weight, of a copolymer CP that comprises

(i) repeat units A of general structure (I),

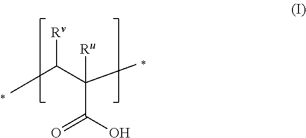

and
(ii) repeat units B of general structure (II),

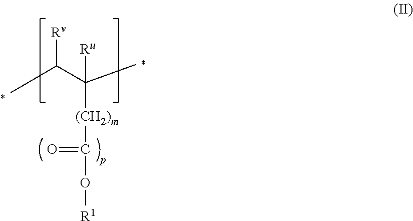

where
each R^{u} is independently hydrogen or a methyl group,
each R^{v} is independently hydrogen or COOM, where M is independently H, an alkali metal, or an alkaline earth metal,
m=0, 1, 2 or 3,
p=0 or 1,
each R¹ is independently —[YO]ₙ—R⁴, where Y is a C2 to C4 alkylene and R⁴ is H, C1 to C20 alkyl, cyclohexyl or alkylaryl, and n=2-350, and
the repeat units A and B in the copolymer CP have a molar ratio
A:B within a range from 10:90 to 90:10,
characterized in that the method comprises or consists of the following steps:
a) producing a mixture of at least one copolymer CP, at least one base, and water, wherein the molar ratio of base to copolymer CP is selected such that a degree of neutralization of at least 55%, preferably at least 75%, more preferably at least 95%, especially preferably at least 100%, in particular at least 110%, results,
b) optionally drying the neutralized aqueous preparation from step a), and
c) optionally comminuting the material obtained in step b).

It has been found that neutralizing copolymers CP in a process of the invention affords dispersants in solid form and having a melting point/softening point of >50° C., preferably of >100° C., more preferably of >180° C., in particular of >220° C. Solid polymers with such high melting points/softening points have the advantage that they no longer melt during storage and transport and therefore result in less caking.

It was also found that the plasticizing effect of the copolymers CP initially decreases at a low degree of neutralization and increases again only at higher degrees of neutralization. This means that, for example, a gypsum mixture comprising a neutralized copolymer CP shows the same flow behavior as the same gypsum mixture comprising the same copolymer CP in non-neutralized form only from a degree of neutralization in the copolymer CP of >100%. A high plasticizing effect is desirable.

Finally, it was found that a copolymer CP with a relatively high degree of neutralization has a stronger retarding effect on the setting of gypsum mixtures than the same copolymer CP with a low degree of neutralization. A stronger retarding effect can be advantageous in order to ensure a sufficient working time for gypsum mixtures.

### Ways of Executing the Invention

In a first aspect, the present invention relates to a process for producing a dispersant in solid form, wherein the dispersant comprises at least 90% by weight, preferably at least 95% by weight, in particular at least 98.5% by weight, in each case based on the total weight of dispersant, of at least one copolymer CP, wherein the copolymers CP comprise the following constituents:

(i) repeat units A of general structure (I),

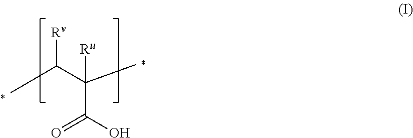

and
(ii) repeat units B of general structure (II),

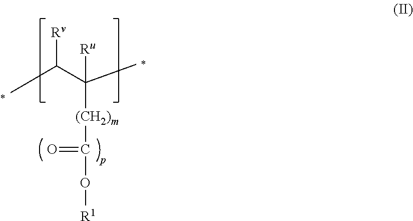

where
each R^{u} is independently hydrogen or a methyl group,
each R^{v} is independently hydrogen or COOM, where M is independently H, an alkali metal, or an alkaline earth metal,
m=0, 1, 2 or 3,
p=0 or 1,
each R¹ is independently —[YO]ₙ—R⁴, where Y is a C2 to C4 alkylene and R⁴ is H, C1 to C20 alkyl, cyclohexyl or alkylaryl, and n=2-350,
and wherein the repeat units A and B in the copolymer CP have a molar ratio A:B within a range from 10:90 to 90:10,
characterized in that the method comprises the following steps:
a) producing a mixture of at least one copolymer CP, at least one base, and water, wherein the molar ratio of base to copolymer CP is selected such that a degree of neutralization of at least 55%, preferably at least 75%, more preferably at least 95%, especially preferably at least 100%, in particular at least 110%, results,
b) optionally drying the neutralized aqueous preparation from step a), and
c) optionally comminuting the material obtained in step b).

A dispersant in the context of the present invention is accordingly a polymer or a mixture of polymers comprising at least 90% by weight, preferably at least 95% by weight, in particular at least 98.5% by weight, of at least one copolymer CP as described above. A dispersant is thus in particular a polycarboxylate ether or polycarboxylate ester or a mixture of polycarboxylate ethers and/or polycarboxylate esters.

In a preferred embodiment, a dispersant of the invention comprises exactly one copolymer CP.

Dispersants are for the purposes of the present invention used preferably in mineral binder compositions. The dispersants of the present invention bring about in particular a reduction in the water requirement of mineral binder compositions. This means that less water is required to establish a given flow behavior in a mineral binder composition when this composition contains a dispersant, compared to the same composition without dispersant. This is equivalent to a plasticizing effect. This property is usually measured by determining the slump, for example in accordance with standard EN 12350-5.

The term “dispersant in solid form” refers in the context of the present invention to a polymer or a mixture of polymers comprising at least 90% by weight, preferably at least 95% by weight, in particular at least 98.5% by weight, of a copolymer CP as described above, which at 23° C. and a pressure of 1 bar is present in the solid state. Dispersants in solid form may be present particularly in the form of powders, flakes, pellets or slabs. In a particularly preferred embodiment, the solid dispersant is obtained in a process of the invention as a powder.

The solid dispersant, in particular the pulverulent dispersant, that is obtained from a process of the invention preferably has a particle size distribution with a D90 value of <300 μm, preferably <270 μm, in particular <255 μm, a D10 value of <60 μm, preferably <50 μm, in particular <45 μm, and a D50 value of between 70-130 μm, preferably 75-120 μm, in particular 80-110 μm.

A “particle size distribution” in the context of the present invention is a distribution function that relates the relative amount of particles present to their size. The particle size distribution can be described by different D values. For example, the D10 value corresponds to the particle diameter at which 10% of all particles in a given distribution are smaller and 90% of all particles in a given distribution are larger. Conversely, the D90 value corresponds to the diameter at which 90% of all particles in a given distribution are smaller. Unless otherwise specified, the term “particle size” refers for the present purposes to an average value of the particle size distribution of a solid. This average value is stated as the D50 value of a given particle size distribution and represents the value for the particle diameter at which 50% of all particles in a given distribution are smaller and 50% of all particles in a given distribution are larger. The D50 value is therefore a numerical median. A particle size of non-spherical or irregular particles is preferably represented by the equivalent spherical diameter of a sphere of equal volume.

The particle size distribution and thus the different D values and the particle size defined above can be determined by laser light scattering, preferably in accordance with the ISO 13320:2009 standard. In particular, a Mastersizer 2000 analyzer with a Hydro 2000G dispersing unit and the Mastersizer 2000 software from Malvern Instruments GmbH (Germany) can be used for this purpose.

Copolymers CP of the present invention are polycarboxylate ethers and/or polycarboxylate esters.

Copolymers CP of the present invention comprise

(i) repeat units A of general structure (I),

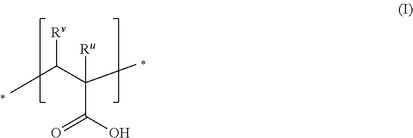

and
(ii) repeat units B of general structure (II),

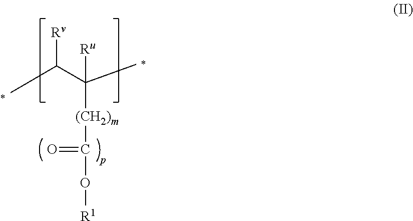

where
each R^{u} is independently hydrogen or a methyl group,
each R^{v} is independently hydrogen or COOM, where M is independently H, an alkali metal, or an alkaline earth metal,
m=0, 1, 2 or 3,
p=0 or 1,
each R¹ is independently —[YO]ₙ—R⁴, where Y is a C2 to C4 alkylene and R⁴ is H, C1 to C20 alkyl, cyclohexyl or alkylaryl, and n=2-350,
and wherein the repeat units A and B in the copolymer CP have a molar ratio A:B within a range from 10:90 to 90:10.

In a preferred embodiment, n=10-250, more preferably 30-200, especially preferably 35-200, in particular 40-110.

In a particularly preferred embodiment, the copolymer CP comprises repeat units A of general structure (I) and also repeat units B of general structure (II), wherein the molar ratios of A to B are within a range from 20:80 to 80:20, more preferably 30:70 to 80:20, in particular 35:65 to 75:25.

A copolymer CP preferably has an average molar mass M_{w} in the range of 1000-1 000 000, particularly preferably 1500-500 000, very particularly preferably 2000-100 000, in particular 3000-75 000 or 3000-50 000, g/mol. The molar mass M_{w} is here determined by gel-permeation chromatography (GPC) with polyethylene glycol (PEG) as standard. This technique is known per se to the person skilled in the art.

Copolymers CP of the invention may be random or nonrandom copolymers. Nonrandom copolymers are in particular alternating copolymers or block or gradient copolymers or mixtures thereof.

According to specific embodiments, the parameters R^{u}, R^{v}, R¹, m, and p of the repeat units A and B are in a copolymer CP selected as follows:

R^{u} is independently hydrogen or a methyl group,
R^{v} is hydrogen,
m=1 or 2,
p=0,
each R¹ is independently —[YO]ₙ—R⁴, where Y is a C2 to C4 alkylene and R⁴ is H, C1 to C20 alkyl, cyclohexyl or alkylaryl, and n=2-350.

According to further specific embodiments, the parameters R^{u}, R″, R¹, m, and p of the repeat units A and B are in a copolymer CP selected as follows:

R^{u} is independently hydrogen or a methyl group,
R^{v} is hydrogen,
m=0,
p=1,
each R¹ is independently —[YO]ₙ—R⁴, where Y is a C2 to C4 alkylene and R⁴ is H, C1 to C20 alkyl, cyclohexyl or alkylaryl, and n=2-350.

Copolymers CP of the invention that are random copolymers can be produced by free-radical polymerization of mixtures comprising at least one olefinically unsaturated carboxylic acid monomer of general structure (Ia)

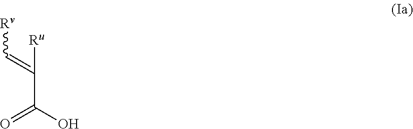

and at least one olefinically unsaturated monomer of general structure (IIa)

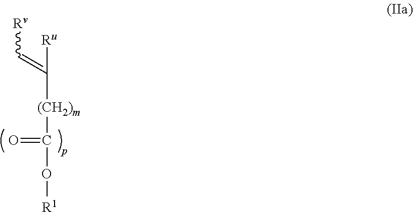

where R^{u}, R^{v}, m, p, R¹, and n are as defined above and the bond represented by the squiggly line denotes both cis and trans double bond isomers or a mixture thereof.

Suitable conditions for performing free-radical polymerizations are known per se to the person skilled in the art and are described for example in EP 1 103 570 (Nippon Shokubai).

Copolymers CP of the invention that are nonrandom copolymers, in particular block or gradient copolymers, may preferably be produced by living free-radical polymerization. The techniques of living free-radical polymerization include inter alia nitroxide-mediated polymerization (NMP), atom-transfer free-radical polymerization (ATRP), and reversible addition-fragmentation chain-transfer polymerization (RAFT). Living free-radical polymerization proceeds essentially in the absence of irreversible transfer or termination reactions. The number of active chain ends is low and remains essentially constant during the polymerization. This is achieved, for example in the case of RAFT polymerization, by the use of a RAFT agent and an only small amount of initiator. This enables essentially simultaneous growth of the chains that continues throughout the polymerization process. This gives rise to the option of using this process to produce block or gradient copolymers, resulting correspondingly in a narrow molecular-weight distribution or polydispersity in the polymer. This is not possible in the case of conventional “free-radical polymerization” or free-radical polymerization carried out in a non-living manner. Particularly advantageously, nonrandom copolymers of the present invention may be produced by means of RAFT polymerization. Advantageous RAFT agents are dithioesters, dithiocarbamate, trithiocarbonate or xanthate. Advantageous initiators are azobisisobutyronitrile (AlBN), α,α′-azodiisobutyramidine dihydrochloride (AAPH) or azobisisobutyramidine (AlBA).

In accordance with a particularly preferred embodiment, the free-radical polymerization is carried out as a solution polymerization, especially in a solvent containing water. It is very particularly preferable to carry out the polymerization in pure water. It is preferable to run the free-radical polymerization for producing copolymers CP of the invention up to a conversion of at least 75%, preferably at least 80%, more preferably at least 90%, even more preferably at least 95%, in particular at least 98% or more, in each case based on the total molar amount of monomers present.

Copolymers CP of the invention can also be produced by a polymer-analogous reaction. In particular, copolymers CP of the invention can be produced by the esterification of a homo- or copolymer comprising repeat units of general structure (I) with polyalkylene glycols of general structure (III)

HO—R¹ (III),

where R¹ is as defined above.

Processes suitable for producing copolymers CP of the invention by esterification are known per se to the person skilled in the art and are described for example in EP 1138697 (Sika AG).

In a particularly preferred embodiment, the copolymer CP of the invention arises in a production process through a polymer-analogous esterification in a melt and is in step a) of a process of the invention for producing a solid dispersant used directly in the form of a melt.

In addition to the at least one olefinically unsaturated carboxylic acid monomer of general structure (Ia) and the at least one olefinically unsaturated macromonomer of general structure (IIa), copolymers CP of the invention may comprise one or more further monomers M. These further monomers M may be selected from styrene, ethylene, propylene, butylene, butadiene, isoprene, vinyl acetate, vinyl chloride, acrylonitrile, N-vinylpyrrolidone and/or hydroxyalkyl (meth)acrylates.

It is preferable that the molar proportion of the one or more further monomers M is not more than 66 mol %, preferably not more than 50 mol %, more preferably not more than 25 mol %, especially preferably not more than 10 mol %, in particular not more than 5 mol %, based in each case on all monomers giving rise to the copolymer CP. In a very particularly preferred embodiment, the copolymer CP is essentially free of further monomer units M. A copolymer CP of the invention accordingly consists to an extent of at least 34 mol %, preferably at least 50 mol %, more preferably at least 75 mol %, especially preferably at least 90 mol %, in particular 100 mol %, of the repeat units A and B.

In a very particularly preferred embodiment, the copolymer CP of the present invention accordingly consists of

(i) repeat units A of general structure (I),

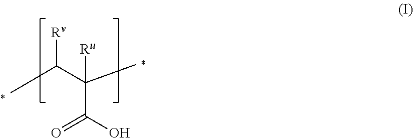

and
(ii) repeat units B of general structure (II),

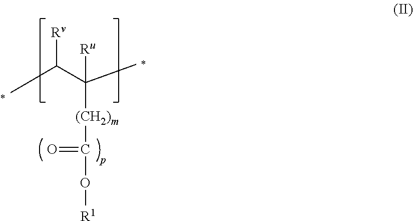

where
each R^{u} is independently hydrogen or a methyl group,
each R^{v} is independently hydrogen or COOM, where M is independently H, an alkali metal, or an alkaline earth metal,
m=0, 1, 2 or 3,
p=0 or 1,
each R¹ is independently —[YO]ₙ—R⁴, where Y is a C2 to C4 alkylene and R⁴ is H, C1 to C20 alkyl, cyclohexyl or alkylaryl, and n=2-350,
and wherein the repeat units A and B in the copolymer CP have a molar ratio A:B within a range from 10:90 to 90:10.

The dispersant of the invention may, in addition to the copolymer CP, comprise further substances selected from the group comprising biocides, antioxidants and/or anticaking agents. Such substances may be present in a dispersant of the invention in an amount of not more than 10% by weight, preferably not more than 5% by weight, in particular not more than 1.5% by weight, in each case based on the total weight of the dispersant. These substances are added to a dispersant of the invention in particular to improve stability and/or effectiveness. The addition of these substances can take place before or during production of a copolymer CP. The addition may however also take place in any of the steps a) to d) of a process of the invention.

Examples of suitable antioxidants are described for example in WO 00/17263 and include alkylated phenols, alkylated hydroquinones, and alkylidene bisphenols. Examples of anticaking agents are cellulose in powder form, magnesium stearate, calcium carbonate, dolomite, clay, kaolin, vermiculite, bantonite, talc, slag, fly ash, silicates or aluminosilicates and silicon dioxide, especially in the form of fumed silica or precipitated silica.

In one particular embodiment, the present invention relates to a process for producing a dispersant in solid form, wherein the dispersant comprises at least 90% by weight, preferably at least 95% by weight, in particular at least 98.5% by weight, in each case based on the total weight of dispersant, of a copolymer CP.

In another particular embodiment, the present invention relates to a process for producing a dispersant in solid form, wherein the dispersant consists essentially of a copolymer CP.

The process of the invention for producing a dispersant in solid form comprises the following steps
a) producing a mixture of at least one copolymer CP, at least one base, and water, wherein the molar ratio of base to copolymer CP is selected such that a degree of neutralization of at least 55%, preferably at least 75%, more preferably at least 95%, especially preferably at least 100%, in particular at least 110%, results,
b) optionally drying the neutralized aqueous preparation from step a), and
c) optionally comminuting the material obtained in step b).

In a preferred embodiment, the process of the invention for producing a dispersant in solid form consists of the steps of
a) producing a mixture of at least one copolymer CP, at least one base, and water, wherein the molar ratio of base to copolymer CP is selected such that a degree of neutralization of at least 55%, preferably at least 75%, more preferably at least 95%, especially preferably at least 100%, in particular at least 110%, results,
b) drying the neutralized aqueous preparation from step a), and
c) optionally comminuting the material obtained in step b).

In a very particularly preferred embodiment, the process of the invention for producing a dispersant in solid form consists of the steps of
a) producing a mixture of a copolymer CP, at least one base, and water, wherein the molar ratio of base to copolymer CP is selected such that a degree of neutralization of at least 55%, preferably at least 75%, more preferably at least 95%, especially preferably at least 100%, in particular at least 110%, results,
b) drying the neutralized aqueous preparation from step a), and
c) comminuting the material obtained in step b).

It has proven particularly advantageous when the proportion of water in the mixture in step a) is 10-90% by weight, preferably 10-60% by weight, more preferably 10-40% by weight, in particular 10% by weight, in each case based on the total weight of the mixture. At a water content of 5% by weight, neutralization is more difficult and no increase in the melting/softening point is achieved.

In a particularly preferred embodiment, the aqueous preparation in step a) thus consists of 10-90% by weight, preferably 10-60% by weight, more preferably 10-40% by weight, in particular 10% by weight, in each case based on the total weight of the aqueous preparation, of water, the remaining part up to 100% by weight consisting of one or more copolymers CP and at least one base.

The mixture in step a) may be prepared in a manner known per se to the person skilled in the art. In particular, it is possible for the at least one copolymer CP to be initially charged and water added thereto, so as to obtain a solution or dispersion of the at least one copolymer CP in water. The copolymer CP may advantageously be initially charged in the form of a melt. The desired amount of base is then added to this solution or dispersion. The base may be present as the bulk substance, particularly in solid form, as a solution or as a slurry. According to a preferred embodiment, the base is added in solid form to the aqueous solution or slurry of the at least one copolymer CP.

However, it is also possible to slurry or dissolve the base in water. This aqueous slurry or suspension of the base is then in a process of the invention added to the at least one copolymer CP. The at least one copolymer CP may be present as the bulk substance or as a solution or dispersion. When the at least one copolymer CP is present as the bulk substance, it may be advantageous to initially charge the copolymer CP in the form of a melt and to then add the base to this melt. When the copolymer CP is present as a solution or dispersion, it is more particularly a solution or dispersion in water.

In a particularly advantageous embodiment of the process of the invention, the procedure for producing a mixture according to step a) is accordingly as follows:
(i) initially charging at least one copolymer CP in the form of a melt,
(ii) dissolving or slurrying at least one base in water,
(iii) adding the aqueous solution or slurry of the at least one base to the melt of the copolymer CP.

The mixture from step a) comprises at least one base. Suitable bases are in particular alkali metal and alkaline earth metal oxides and hydroxides and (hydrogen) carbonates. LiOH, NaOH, KOH, NaHCO₃, Li₂CO₃, Na₂CO₃, CaO, MgO, Ca(OH)₂, Mg(OH)₂, CaCO₃, MgCO₃, CaMg(CO₃)₂, and mixtures thereof have proved particularly suitable. In a particularly preferred embodiment, the at least one base in step a) is selected from the group of alkaline earth metal oxides or hydroxides, in particular CaO or Ca(OH)₂.

The degree of neutralization corresponds in the present case to the molar ratio of hydroxide ions that form in an aqueous medium from the at least one base to the carboxylic acid groups —COOH of the copolymers CP, expressed in %. A degree of neutralization of 55% accordingly means that the molar ratio of OH⁻ ions formed to carboxylic acid groups is 0.55:1. A degree of neutralization of 100% means that the molar ratio of OH⁻ ions formed to carboxylic acid groups is 1:1. A degree of neutralization of 110% means that the molar ratio of OH⁻ ions formed to carboxylic acid groups is 1.1:1. In the latter case, the OH⁻ ions are thus present in a stoichiometric excess. The degree of neutralization can in the present case in particular be calculated with the assumption that the employed base dissociates completely in aqueous media, with the stoichiometric formation of OH⁻ ions.

A degree of neutralization of at least 55%, preferably at least 75%, more preferably at least 95%, especially preferably at least 100%, in particular at least 110%, has been found to be advantageous, since this makes it possible to produce solid dispersants having particularly high melting points/softening points. However, a degree of neutralization of greater than 150% is generally no longer advantageous.

Neutralization preferably takes place at a temperature of 20-80° C. and standard pressure, with constant stirring.

The neutralized aqueous preparation may be dried in a manner known per se to the person skilled in the art, for example in a drum dryer or in a belt dryer. It is however preferable that the neutralized aqueous preparation is not dried in a spray-drying process, since, as already mentioned, the thermal stress on the polymeric dispersants is very high in such processes and there is also an increased risk of dust explosions.

The process of the invention comprises in particular then a step of drying the neutralized mixture obtained in step a) when the water content in the mixture is greater than or equal to 13% by weight, in particular greater than or equal to 15% by weight, in each case based on the total weight of the mixture. If water is present in the overall mixture in a proportion of less than 13% by weight, more particularly in a proportion of 10% by weight, neutralized copolymers CP solidify to a solid dispersant even without drying. However, it is generally preferable when the process of the invention comprises a step b) of drying.

In a preferred embodiment, the neutralized aqueous preparation is in step b) dried at a temperature of 20-180° C. The pressure here may be standard pressure. However, it is also possible to dry under reduced pressure, for example at a pressure of 900 mbar or lower, preferably at 500 mbar or lower. Lower pressure allows more rapid drying and/or a lower drying temperature. Rapid drying results in a solid dispersant that has reduced stickiness. It is therefore particularly preferable to carry out the drying process at 20-180° C. and a maximum pressure of 100 mbar. The dried dispersant has a residual moisture content of <5%, preferably <4%, in each case based on the total weight of the dried dispersant.

The dried dispersant may be comminuted, in particular, by crushing and/or milling. Examples of suitable mills are hammer mills, colloid mills, corundum mills, ball mills, planetary mills, impact mills, tube mills, rotor mills, disk mills, cutting mills, vibratory mills, jet mills, pin mills, drum mills, vertical mills, cyclone mills or roller mills. It can be particularly advantageous to carry out comminution in a cryogenic grinding process. Comminution, more particularly milling, can therefore take place at temperatures of between −196° C. and +80° C.

The dispersant in solid form is obtained with a particle size distribution having a D90 value of <300 μm, preferably <270 μm, in particular <255 μm, a D10 value of <60 μm, preferably <50 μm, in particular <45 μm, and a D50 value of between 70-130 μm, preferably 75-120 μm, in particular 80-110 μm.

In a further aspect, the present invention relates to a solid dispersant obtainable by a process as described above.

In a further aspect the present invention relates to the use of a solid dispersant obtained by a process as described above in a mineral binder composition.

The expression “mineral binder” is in the present case understood to mean a binder that reacts in the presence of water in a hydration reaction to form solid hydrates or hydrate phases. This may for example be a hydraulic binder (e.g. cement or hydraulic lime), a latently hydraulic binder (e.g. slag), a pozzolanic binder (e.g. fly ash) or a nonhydraulic binder (gypsum or white lime).

A mineral binder composition is accordingly a composition comprising at least one mineral binder.

A mineral binder composition may for example be a dry mortar. A mineral binder composition may also be a water-mixed mortar or concrete. A mineral binder composition may also be a gypsum mixture.

More particularly, the mineral binder may comprise a hydraulic binder, preferably cement. Particular preference is given to a cement having a cement clinker content of 35% by weight. More particularly, the cement is a portland cement of the CEM I, CEM II, CEM III, CEM IV or CEM V type in accordance with standard EN 197-1, an aluminate cement, more particularly an aluminous cement in accordance with DIN EN 14647, a calcium sulfoaluminate cement or mixtures of the cements mentioned.

According to a particular embodiment, the mineral binder consists essentially of portland cement.

According to a further particular embodiment, the mineral binder consists essentially of a mixture of portland cement and aluminate cement or portland cement and calcium sulfoaluminate cement, wherein the weight ratio of portland cement to aluminate cement or portland cement to calcium sulfoaluminate cement is within a range from 10:1 to 1:10.

The mineral binder composition comprises preferably at least one hydraulic binder, in particular at least one cement, in a content of at least 5% by weight, preferably of at least 20% by weight, particularly preferably of at least 35% by weight, very particularly preferably of at least 65% by weight, especially 95% by weight, in each case based on the dry mass of the mineral binder composition.

Alternatively, it may also be advantageous when the mineral binder or the mineral binder composition comprises or essentially consists of other binders. These are especially latently hydraulic binders and/or pozzolanic binders. Suitable latently hydraulic and/or pozzolanic binders are, for example, slag, fly ash, silica dust, microsilica, metakaolin, tuff, trass, volcanic ash, zeolites and/or burnt oil shale.

In one embodiment, the mineral binder contains 5-95% by weight, in particular 5-65% by weight, more preferably 15-35% by weight, in each case based on the total dry mass of the mineral binder, of latently hydraulic and/or pozzolanic binders. Advantageous latently hydraulic and/or pozzolanic binders are slag and/or fly ash.

In a particular embodiment, the mineral binder comprises a hydraulic binder, in particular cement, and a latently hydraulic and/or pozzolanic binder, preferably slag and/or fly ash. The proportion of the latently hydraulic and/or pozzolanic binder is here more preferably 5-65% by weight, more preferably 15-35% by weight, while at least 35% by weight, in particular at least 65% by weight, in each case based on the total dry mass of the mineral binder.

In a further embodiment, the mineral binder may comprise or essentially consist of calcium sulfate dihydrate, α-calcium sulfate hemihydrate, β-calcium sulfate hemihydrate, anhydrite and/or lime.

In a particular embodiment, the mineral binder is a ternary binder. In this embodiment, the mineral binder consists essentially of (i) portland cement, (ii) aluminate cement or calcium sulfoaluminate cement, and (iii) one or more calcium sulfate carriers selected from the group consisting of calcium sulfate dihydrate, α-calcium sulfate hemihydrate, β-calcium sulfate hemihydrate, and anhydrite. The weight ratios of the three components may vary within wide ranges.

According to preferred embodiments, the mineral binder is accordingly selected from the group comprising cement, in particular portland cement, aluminate cement and calcium sulfoaluminate cement, calcium sulfate dihydrate, α-calcium sulfate hemihydrate, β-calcium sulfate hemihydrate, anhydrite, lime, industrial and synthetic slags, in particular blast furnace slags, foundry sand, foundry sand flour, electrothermal phosphorus slags, copper slags and stainless steel slags, pozzolans, in particular fly ashes, microsilica, metakaolin, natural pozzolans, in particular tuff, trass, and volcanic ash, natural and synthetic zeolites, burnt oil shale or mixtures thereof.

According to a preferred embodiment, the mineral binder is a binder based on calcium sulfate and is selected from the group comprising α-calcium sulfate hemihydrate, β-calcium sulfate hemihydrate, anhydrite, and mixtures thereof. The proportion of calcium sulfate hemihydrate in the entire mineral binder is advantageously at least 80% by weight, preferably at least 90% by weight, more preferably at least 95% by weight, in each case based on the total weight of the mineral binder. Mineral binders based on calcium sulfate can be based on FGD gypsum, phosphogypsum or else natural gypsum. They are used in particular in powder form. The particle size distribution of the calcium sulfate-based binders can be determined for example by laser diffraction in accordance with ISO 13320:2009, as described hereinabove. The average particle size D50 of inventive mineral binders based on calcium sulfate is preferably below 100 μm, preferably below 60 μm, and above 0.5 μm, i.e. for example within a range from 5 μm to 50 μm. Suitable mineral binders based on calcium sulfate are available for example under the trade name Hartformgips from Saint-Gobain Formula GmbH, under the trade name Alpha-Halbhydrat from Knauf, or under the trade name Raddichem from Casea.

Mineral binders may however for the purposes of the present invention also be mixtures of calcium sulfate-based binders and at least one cement, as defined hereinabove. Such mixtures have the advantage of combining the properties of rapid evolution of strength with low shrinkage.

The mineral binder composition may likewise comprise aggregates, for example limestone, quartz flours, sand, gravel and/or pigments.

In a further aspect, the present invention relates to mineral binders or mineral binder compositions, in particular dry mortars that comprise at least one pulverulent dispersant produced in a process of the invention. The present invention therefore provides a mineral binder composition comprising
a) 5-60% by weight, preferably 10-45% by weight, more preferably 12-30% by weight, of one or more mineral binders selected from the group consisting of portland cement, aluminate cement, calcium sulfoaluminate cement, calcium sulfate dihydrate, α-calcium sulfate hemihydrate, β-calcium sulfate hemihydrate, anhydrite, lime, slag, fly ash, microsilica, metakaolin, tuff, trass, volcanic ash and burnt oil shale,
b) 0.01-10% by weight, preferably 0.05-5% by weight, more preferably 0.1-2% by weight, in particular 0.15-0.8% by weight, of at least one solid dispersant obtainable by a process as described above,
c) 30-90% by weight, preferably 40-80% by weight, in particular 40-75% by weight, of at least one aggregate selected from the group consisting of limestone, quartz flour, sand, gravel, and pigments.

The mineral binder composition may be in the form of a dry, pulverulent composition or in the form of a liquid or paste composition, wherein liquid or paste binder compositions contain an appropriate proportion of water. The mineral binder composition may also be in the form of a fully hardened mineral binder composition—for example a shaped body.

The amount of water in a dry mineral binder composition is advantageously <5% by weight, preferably <1% by weight, in particular <0.3% by weight, in each case based on the total weight of the dry mineral binder composition. The weight ratio of water to mineral binder in a paste mineral binder composition is advantageously in the range from 0.2-0.8, preferably 0.25-0.6, in particular 0.3-0.5.

Finally, this invention relates to gypsum mixtures comprising at least one pulverulent dispersant produced in a process of the invention. The present invention therefore also provides a mineral binder composition comprising
a) 30-99.9% by weight, preferably 50-99% by weight, in particular 60-95% by weight, of one or more mineral binders selected from the group consisting of calcium sulfate dihydrate, α-calcium sulfate hemihydrate, β-calcium sulfate hemihydrate, and anhydrite,
b) 0.01-10% by weight, preferably 0.05-5% by weight, more preferably 0.1-2% by weight, in particular 0.15-0.8% by weight, of at least one solid dispersant obtainable by a process as described above,
c) optionally 0.5-25% by weight, preferably 1-15% by weight, in particular 1-5% by weight, of one or more mineral binders selected from the group consisting of portland cement, aluminate cement, calcium sulfoaluminate cement, lime, slag, fly ash, microsilica, metakaolin, tuff, trass, volcanic ash and burnt oil shale,
d) optionally aggregates selected from the group consisting of limestone, quartz flour, sand, gravel, and pigments.

Further embodiments are described in the examples that follow. These should be regarded as illustrative but not limiting in respect of the present invention.

### EXAMPLES

### Example 1—Preparation of Solid Dispersants

A copolymer CP having a backbone of acrylic acid and methacrylic acid (molar ratio 1:1, Mn of the backbone: 6000 g/mol) and methoxy-terminated polyethylene glycol side chains (Mn of the side chain: 5000 g/mol) with a molar ratio of acid to side chain of 12:1 was heated to 90° C. To the resulting melt of the copolymer CP was added a slurry of Ca(OH)₂ in water.

For the preparation of examples 1-4, the respective amount of Ca(OH)₂ shown in Table 1 was slurried in the specified amount of water and added to the copolymer CP.

The resulting mixtures were stirred at 20° C. for 2 min on a high-speed stirrer, then dried in an oven at 60° C. to a residual moisture content of <5% and then ground. This afforded inventive pulverulent dispersants (examples 1-4) having the degrees of neutralization and residual moisture contents shown in Table 1.

Reference 1, which is noninventive, was prepared as described above. However, Ca(OH)₂ was added directly, without slurrying in water, to a melt of the copolymer CP. Cooling and grinding of the melt afforded reference 1.

TABLE 1
Preparation of polymer powders 1-4

| | Ca(OH)₂ | HO | H₂O | | |
|---|---|---|---|---|---|
| | [mg/g | [mg/g | [% by | Degree of | Residual |
| Example | polymer] | polymer] | wt.]* | neutralization | moisture |
| Reference | 80 | 0 | 0 | 110 | n.d. |
| 1 | | | | | |
| 1 | 80 | 120 | 10 | 110 | 3.8 |
| 2 | 80 | 462 | 30 | 110 | 3.3 |
| 3 | 69 | 119 | 10 | 95 | n.d. |
| 4 | 40 | 116 | 10 | 55 | n.d. |

*based on the total mass of the mixture
n.d.: not determined

### Example 2— Determination of Melting Points/Softening Points

Melting points/softening points were measured using an M-560 melting point apparatus from Büchi AG (measurement range: 50-400° C., heating rate: 20° C./min, apparatus calibrated against 4-nitrotoluene, diphenylacetic acid, caffeine, and potassium nitrate).

The inventive polymer powders 1˜4 did not melt, but softened followed by decomposition. Table 2 below shows the results of the measurement.

The noninventive reference 2 corresponds to reference 1, with the difference that no Ca(OH)₂ was added to reference 2.

TABLE 2
Melting/softening points and decomposition points
of the polymer powders

| | Melting point/softening | Decomposition point |
|---|---|---|
| Example | point [° C.] | [° C.] |
| Reference | 60 | n.d. |
| 1 | | |
| Reference | 60 | n.d. |
| 2 | | |
| 1 | 261 | 311 |
| 2 | n.d. | n.d. |
| 3 | 225 | 282 |
| 4 | 176 | 279 |

n.d.: not determined

It is found that higher melting points are attained with increasing degree of neutralization. Reference 1 demonstrates clearly that it is not possible to increase the melting point by neutralizing directly in the melt. The unneutralized reference 2 shows a low melting point.

### Example 3— Testing of the Polymer Powders in Gypsum Mixtures

0.4 g of one of the inventive polymer powders 1-4 or the noninventive reference sample 2 was in each case dissolved in 106 g of water. To this was added 200 g of calcium sulfate β-hemihydrate and 0.2 g of calcium sulfate dihydrate and the resulting slurry was allowed to stand for 15 seconds. The mixture was then stirred intensively by hand for 30 seconds.

A mini-cone 50 mm in diameter and 51 mm in height was then filled with the resulting slurry and this was allowed to stand for 75 seconds. The slump (ABM) in millimeters was then determined. This was done by lifting the mini-cone and measuring the diameter of the gypsum cake that formed, once no more flow was observed. The time interval between completing the mixing process and lifting the mini-cone was 2 minutes. The diameter in mm is referred to as the slump.

The initial setting time and the final setting time were determined by the knife-cut method in accordance with DIN EN 13279-2:2014-03 and the thumb pressure method. The initial setting time (VB) has been reached when, after a knife cut through the gypsum cake, the cut edges no longer flow together. The final setting time (VE) has been attained when water no longer issues from the gypsum cake when pressing down with a finger with pressure of approx. 5 kg. Alternatively, the initial setting time and final setting time can also be determined using the Vicat needle apparatus in accordance with DIN EN 13279-2:2014-03.

Table 3 below gives an overview of the results. The noninventive example reference 3 is a gypsum mixture without addition of polymer powder. Reference 3 was prepared as described above from 200 g of calcium sulfate β-hemihydrate, 0.2 g of calcium sulfate dihydrate, and 106 g of water, without addition of a polymer powder.

TABLE 3
Results for the gypsum mixtures

| Example | Slump [mm] | VB [min] | VE [min] |
|---|---|---|---|
| Reference | 140 | 3.00 | 8.00 |
| 3 | | | |
| Reference | 184 | 4.00 | 10.00 |
| 2 | | | |
| 1 | 188 | 3.66 | 9.75 |
| 2 | 188 | 3.58 | 9.92 |
| 3 | 175 | 3.50 | 9.33 |
| 4 | 167 | 3.42 | 9.25 |

It is found that dispersants of the invention bring about an improvement in slump with increasing degree of neutralization. At a degree of neutralization of 110% (examples 1 and 2), the plasticizing effect corresponds approximately to that of the non-neutralized reference 2.

It is additionally found that, at low degrees of neutralization, there is initially a less pronounced retarding effect than when adding a non-neutralized polymer powder, but that this increases again with increasing degree of neutralization.

1. A process for producing a dispersant in solid form, wherein the dispersant comprises at least 90% by weight in each case based on the total weight of dispersant, of at least one copolymer CP, wherein the copolymers CP comprise the following constituents:
(i) repeat units A of general structure (I), 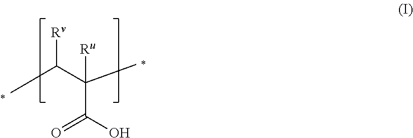
and
(ii) repeat units B of general structure (II), 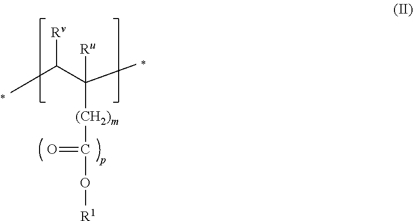
where
each R^{u} is independently hydrogen or a methyl group,
each R^{v} is independently hydrogen or COOM, where M is independently H, an alkali metal, or an alkaline earth metal,
m=0, 1, 2 or 3,
p=0 or 1,
each R¹ is independently —[YO]ₙ—R⁴, where Y is a C2 to C4 alkylene and R⁴ is H, C1 to C20 alkyl, cyclohexyl or alkylaryl, and n=2-350, and
the repeat units A and B in the copolymer CP have a molar ratio
A:B within a range from 10:90 to 90:10,
wherein the process comprises the following steps:
a) producing a mixture of at least one copolymer CP, at least one base, and water, wherein the molar ratio of base to copolymer CP is selected such that a degree of neutralization of at least 55%, results,
b) optionally drying the neutralized aqueous preparation from step a), and
c) optionally comminuting the material obtained in step b).

2. The process for producing a dispersant in solid form as claimed in claim 1, wherein the dispersant comprises at least 90% by weight in each case based on the total weight of dispersant, of a copolymer CP, wherein the copolymer CP comprises the following constituents:
(i) repeat units A of general structure (I) 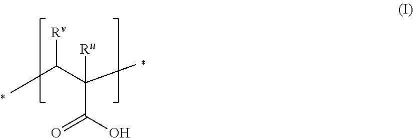
and
(ii) repeat units B of general structure (II), 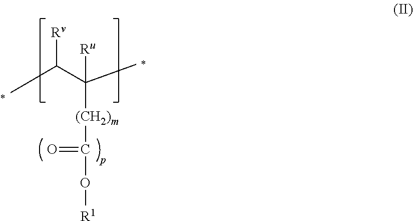
where Ru, Rv, m, p, and R1 and a molar ratio A:B are as defined in claim 1,
wherein the process consists of the following steps:
a) producing a mixture of a copolymer CP, at least one base, and water, wherein the molar ratio of base to copolymer CP is selected such that a degree of neutralization of at least 55% results,
b) drying the neutralized aqueous preparation from step a), and
c) comminuting the material obtained in step b).

3. The process as claimed in claim 1, wherein the one or more copolymers CP consist to an extent of at least 34 mol % of the repeat units A and B.

4. The process as claimed in claim 1, wherein the proportion of water in the mixture in step a) is 10-90% by weight, in each case based on the total weight of the mixture.

5. The process as claimed in claim 1, wherein the base is selected from the group of alkali metal and alkaline earth metal oxides, hydroxides, hydrogen carbonates and/or carbonates.

6. The process as claimed in claim 1, wherein the neutralized aqueous preparation is in step b) dried at a temperature of 20-180° C.

7. The process as claimed in claim 1, wherein the neutralized aqueous preparation is in step b) dried at standard pressure.

8. The process as claimed in claim 1, wherein the neutralized aqueous preparation is in step b) dried at a pressure of 900 mbar or lower, preferably at 500 mbar or lower.

9. The process as claimed in claim 1, wherein the solid dispersant is a powder.

10. The process as claimed in claim 1, wherein the solid dispersant has a particle size distribution with a D90 value of <300 μm, a D10 value of <60 μm, and a D50 value of between 70-130 μm.

11. The process as claimed in claim 1, wherein the solid dispersant comprises further substances selected from the group comprising biocides, antioxidants and/or anticaking agents.

12. A solid dispersant obtainable by a process as claimed in claim 1.

13. A method of using the solid dispersant as claimed in claim 12, comprising
applying the solid dispersant to a mineral binder composition.

14. A mineral binder composition comprising
a) 5-60% by weight, of one or more mineral binders selected from the group consisting of portland cement, aluminate cement, calcium sulfoaluminate cement, calcium sulfate dihydrate, α-calcium sulfate hemihydrate, β-calcium sulfate hemihydrate, anhydrite, lime, slag, fly ash, microsilica, metakaolin, tuff, trass, volcanic ash and burnt oil shale,
b) 0.01-10% by weight, of at least one solid dispersant as claimed in claim 12,
c) 30-90% by weight, of at least one aggregate selected from the group consisting of limestone, quartz flour, sand, gravel, and pigments.

15. A mineral binder composition comprising
a) 30-99.9% by weight, of one or more mineral binders selected from the group consisting of calcium sulfate dihydrate, α-calcium sulfate hemihydrate, β-calcium sulfate hemihydrate, and anhydrite,
b) 0.01-10% by weight, of at least one solid dispersant as claimed in claim 12,
c) optionally 0.5-25% by weight, of one or more mineral binders selected from the group consisting of portland cement, aluminate cement, calcium sulfoaluminate cement, lime, slag, fly ash, microsilica, metakaolin, tuff, trass, volcanic ash and burnt oil shale,
d) optionally aggregates selected from the group consisting of limestone, quartz flour, sand, gravel, and pigments.
